(19) United States
(12) Patent Application Publication
(10) Pub. No.: US 2012/0055797 A1
(43) Pub. Date: Mar. 8, 2012

(54) METHOD AND APPARATUS FOR INCREASING THE EFFICIENCY OF ELECTRO-DEWATERING

(75) Inventors: Abderrahmane Dermoune, Sherbrooke (CA); Mostafa Chamoumi, Sherbrooke (CA); Alain Silverwood, St-Eustache (CA); Frédéric Biton, Montreal (CA)

(73) Assignee: GL&V CANADA INC., Montreal (CA)

(21) Appl. No.: 13/139,258

(22) PCT Filed: Dec. 11, 2009
(86) PCT No.: PCT/IB2009/055723

§ 371 Date: Oct. 6, 2011

Related U.S. Application Data
(60) Provisional application No. 61/121,899, filed on Dec. 11, 2008.

(51) Int. Cl. C02F 1/469; C02F 11/14; C02F 11/12

(52) U.S. Cl. 204/553; 204/649

(57) ABSTRACT

It is an object of the present invention to provide an improved method of electro-dewatering substances by increasing the efficiency with which water is removed from the substances, thus permitting substances to attain higher dryness levels with the same energy input and surface area, or to attain similar dryness levels with less energy input or less surface area. The method comprises placing the substance between at least two electrodes, at least one of which is adapted to allow fluid evacuation, depositing an electrolyte at the interface between the substance and one of the electrodes, wherein the two previous steps can be performed in any order, and, before impregnation of the electrolyte into the substance can occur, submitting the substance to a combination of pressure and electrical current so as to remove liquid from the substance; wherein the electrolyte should be added in sufficient quantity to substantially reduce or prevent the voltage drop that occurs near the at least one electrode and in sufficient volume to allow dispersion over the entire surface of the substance.

### TECHNICAL FIELD

The present invention relates to the field of electro-dewatering and in particular, to new methods and apparatuses for increasing the efficiency of electro-dewatering.

### BACKGROUND

Sludge is the semi-liquid residual material left from wastewater treatment processes. Sludge is highly charged with organic materials and toxic products and it is therefore critical not to simply redirect the pollution that originally affected water to other media such as soil and air. As sludge volume increases with population and industrial activity growth, treating and disposing of sludge is a constant challenge for both public and privately-held wastewater treatment plants (WWTP). In a context of ever-tightening environmental regulations and budgets, WWTP operators need to find new and viable alternatives allowing for efficient and economical sludge disposal or reuse.

In most situations involving the production of large amounts of sludge such as at municipal or industrial water treatment plants, significant efforts are directed toward removing water from the sludge. The main reason is that plants typically pay a weight/based disposal fee for getting rid of the sludge and paying to move a substance containing essentially water does not make sense. Disposal fees are inversely proportional to landfill capacity and directly proportional to environmental consciousness. It is thus highly desirable to extract as much water as possible from the sludge before final disposal.

One of the ways to increase the dryness of sludge involves the addition of polyelectrolyte flocculants between the Waste Activated Sludge (WAS) and mechanical dewatering steps (e.g. belt press, filter press, centrifuge, screw press). Flocculants are very well known and commonly used to increase the efficiency of mechanical dewatering processes, explaining why most plants are designed to have mixing chambers prior to mechanical dewatering to facilitate flocculent addition. For optimal efficiency, mixing chambers are adapted to generate a homogenous mixture of flocculants in the sludge. Physico-chemical properties and mode of action of flocculants are such that their ability to generate flocs which resist mechanical dewatering are intimately related to their dispersion coefficient.

Electro-dewatering (EDW), the process by which water is removed from a substance with the help of an electric current, is gaining wide ranging interest as a means for increasing sludge dryness as described in PCT publication No. WO2007143840. Indeed, electro-dewatering has many advantages over other methods in terms of its ability to deliver high dryness values with low energy expenditure as well as its ability to generate a sludge which satisfies the most stringent criteria for reuse in agriculture for land application.

In Canadian Pat No 2,179,476, Dermoune teaches of a need to improve electrical transmissivity of an electrode in a soil due to the electrical resistance building up at the immediate vicinity of the electrodes causing a decrease in the performance of the system. In this patent, the purpose of adding electrolyte is to increase the mechanical resistance of the soil by replacing pore water by an electrolyte, which will constitute the new pore material. Electrolyte is added to a soil by electro-injecting it from the tubular perforated electrode in order to improve the electrical transmissivity in the soil. The electrodes of Dermoune are inserted vertically in the soil which is not moved during the process.

In U.S. Pat. No. 5,230,809, Raslonski teaches an electro-dewatering apparatus allowing for the addition of electrolytes in a mixing chamber to insure proper blending of an electrolyte with the sludge before electro-osmosis begins in a dewatering belt. Raslonski also teaches a conductivity measurement device to determine the amount of electrolyte to be added to the sludge.

Kondo (Japanese Pub. No 60-114315) teaches a method to increase the efficiency of electro-dewatering by impregnating the sludge with sodium chloride at a concentration of more than 10% with respect to the solid component of the sludge. In the teachings of Kondo, impregnating the bulk of the sludge with an electrolyte increases the electrical conductivity of electrolyte-poor sludge to increase the efficiency of electro-dewatering.

Because the act of electro-dewatering substances consumes electrical energy, it is desirable to develop new methods and apparatuses that have high electro-dewatering capacity with lower energy consumption or similar dewatering capacity with lower treatment surface area.

### SUMMARY OF THE INVENTION

It is an object of the present invention to provide an improved method of electro-dewatering substances by increasing the efficiency with which water is removed from the substances, thus permitting substances to attain higher dryness levels with the same energy input and surface area, or to attain similar dryness levels with less energy input or less surface area. The method comprises placing the substance between at least two electrodes, at least one of which is adapted to allow fluid evacuation, depositing an electrolyte at the interface between the substance and one of the electrodes, wherein the two previous steps can be performed in any order, and, before impregnation of the electrolyte into the substance can occur, submitting the substance to a combination of pressure and electrical current so as to remove liquid from the substance;

It is another object of the present invention to provide an apparatus for increasing dryness of a substance, the apparatus comprising an inlet for receiving the substance, at least two electrodes adapted to submit the substance to an electric current and pressure, and a delivery mechanism to distribute an electrolyte at an electrode-substance interface, thereby reducing or preventing a voltage loss that occurs during electro-osmotic treatment. The apparatus further comprising a controller to ensure that the treatment is initiated immediately after electrolyte addition so as to avoid impregnation or permeation of the electrolyte into the substance

It is an object of the present invention to increase the efficiency of electro-dewatering by providing a single or a mixture of electrolytes with different properties. For example, when an electrolyte is deposited at the anode-substance interface, a smaller cationic moiety of the electrolyte such as hydrogen (H⁺) or sodium (Na⁺) can more rapidly migrate into the substance to increase conductivity throughout the substance and another larger cationic moiety of an electrolyte such as Ca²⁺ more slowly migrates into the substance, hence helping to decrease or prevent the potential drop that occurs specifically at the anode-substance interface. Furthermore, some cations such as calcium require more solvation and thus drag along with them more water as they migrate toward the cathode. Because organic sludge from different industrial and wastewater treatment plants vary greatly from one another and over time, the optimal electrolyte combinations or timing of addition within the electro-dewatering process will also vary according to substance characteristics, such as, but not limited to pH, conductivity, resistivity, density, temperature, porosity, water content, bacterial and microflora content, type of sludge (aerobic, anaerobic or digested), thickness, treatment time and sludge retention time and time spent in a holding tank.

It is yet another object of the present invention to provide a process allowing to decrease or prevent a voltage drop that occurs at an anode-substance interface by providing an excess of cations at the immediate vicinity of the anode-substance interface to favour electro-osmotic drainage by movement of cations through the substance while, simultaneously, minimizing the counter-productive movement of anions in the substance, as the anions are already in the vicinity of the anode, and the water is generally eliminated by gravity after reaching the cathode.

One of the main drawbacks of electro-dewatering techniques is the drop of potential that occurs at the anode. A drop of potential at the anode can be explained by the decrease in water content of the substance (soil or sludge or other) adjacent to the anode. It is also explained by the decrease of the conductivity of the pore water due to the migration of ions away from the anode and the generated gases during the process. Moreover, a drop of potential can also be explained by an inappropriate contact between the anode and the substance to be dewatered. Thus, the voltage gradient which is directly applied to the substance (soil, sludge or any substance comprising both solid and liquid components) can only be a fraction of the voltage applied to the electrodes. It is thus highly desirable to have a method and an apparatus which would prevent the drop of potential at the anode. One way to prevent or reduce the drop in potential is to insure proper contact between the electrode and the substance which can be achieved by applying pressure through the electrode. Another way to further reduce or even prevent the drop in potential is to add electrolytes which will increase the conductivity of the substance. Finally, physically removing the layer of material of high electrical resistance would also prevent or reduce the voltage drop.

According to one embodiment of the present invention, the electrolyte is dispersed over whole the horizontal surface (i.e. the X- and Y-axes) of the substance but, in order to achieve maximal efficiency, the electrolyte should not be impregnated or mixed through the thickness of the substance (i.e. the Z-axis)(see FIG. 2) as would be required for other processes such as sludge flocculation, sludge coagulation, lime addition.

It is yet another object of the present invention to provide a process for treating substances characterized in that the substance to be treated is added to an electro-dewatering apparatus comprising at least two electrodes including at least one anode and at least one cathode; an electrolyte is homogenously added (sprayed, vaporized, spread, rolled onto, deposited either in liquid or solid form or electro-injected) at the interface of one of the at least two electrodes, wherein electrolyte can be added at the beginning or anywhere throughout the apparatus or process; an electric current is passed through the substance to treat and/or dehydrate the substance by electro-osmosis, wherein a pressure is administered to the substance in order to maintain a substantially constant contact between each electrode and the substance, thus generating a dryer substance and at least one effluent; and a controller for controlling the timing of addition of electrolyte to the substance, wherein the controller receives input about the actual addition of electrolyte to a substance-electrode interface such as that from a probe measuring a decrease in volume of electrolyte in a reservoir and controller output will initiate the electro-dewatering process by generating a specific voltage across the substance and applying a specific pressure through one of the electrodes.

Applicants have discovered that depositing an electrolyte, in either liquid or solid form at the interface between an electrode and the substance to be dewatered with the objective of eliminating the voltage loss that occurs in the vicinity of the electrode, significantly enhances the electro-dewatering process. For maximal efficiency of electrolyte addition, the electro-dewatering process must begin after electrolyte addition so that the electrolyte does not penetrate into or impregnate the sludge before applying pressure and electrical current. The electrolyte can be added at the beginning of the treatment or at any time and place in the active zone of the treatment, as long as the electrolyte is dispersed of the substance area which will be receiving electrical current so as to avoid the formation of preferential current channels which can cause unnecessary energy expenditures and increased temperatures. Addition of electrolyte at the surface (not mixed) allows applicants to increase the efficiency of electro-dewatering by a very significant amount. In some cases, efficiency was increased by as much as 50% by the simple dispersion of electrolyte at the substance-electrode interface.

Substance is used interchangeably throughout the text with any liquid-bearing material and includes, but is not limited to, examples such as municipal sludge, industrial sludge, agro-alimentary sludge such as that from tofu, tomato paste and juices, foraging sludge, mining residues, dredging sludge such as those from ports and canals, pharmaceutical sludge, algae dewatering, lignin solutions for the pulp and paper industry, extraction of essential oils or any liquid bearing material or any material requiring solid/liquid separation.

Experiments have shown that, contrary to expectations, initiating electro-dewatering with the electrolyte dispersed only at the electrode-substance interface (surface), thus creating an electrolyte rich layer, is significantly more efficient than initiating electro-dewatering with the electrolyte homogenously mixed into the substance. Further experiments and retrospective analysis reveals that optimal configuration favours that all electrolyte be added at the electrode-substance interface. The reason electrolytes enhance electro-dewatering processes is that some substances to be dewatered are electrolyte-poor substances or require a more readily available electrolyte. Even when the substances are not electrolyte poor, the process of electro-dewatering depletes the substance of its endogenous electrolytes. Indeed, cations migrate toward the cathode and anions migrate toward the anode, thus depleting even more a substance of its ions. Another way of increasing available electrolytes is to solubilise them through the use of solution that will allow ions to be available for the process (such as acids). Electro-osmosis will occur only in the phase where there is an excess of counter-ions. The greater the co-ion invasion into this phase, the greater will be the reverse drag exerted on the water and, hence, the less will be the net electro-osmotic flow. This can explain why adding an electrolyte to the electrode-substance interface has beneficial effects. Cations must migrate throughout the whole thickness of a substance to reach the cathode whereas anions are already in the vicinity of the anode.

Dispersion of electrolytes at the electrode-substance (anode-sludge) interface must be substantially homogenous to prevent the formation of current channels and requires a sufficient quantity and/or volume of electrolyte to be dispersed over the whole surface of the substance. Formation of current channels in not desirable as, upon their formation, current is not properly dispersed over the surface of the substance to be treated and optimal efficiency is not achieved as a larger portion of the electrical energy will become heat rather than generating an electric field which favours movement of ions. Furthermore, it is important to add only a sufficient quantity of electrolyte to substantially reduce or prevent the voltage drop during electro-osmotic treatment in order to achieve maximal efficiency. Indeed, adding too much electrolyte will lead to greater energy expenditures and a higher cost for purchasing the electrolyte, thereby reducing overall efficiency of the treatment.

It is an object of the present invention to provide an electro-dewatering apparatus which is designed to provide the right amount of electrolyte at the right location of the substance-anode interface. As described in PCT/CA2007/001052 designating the United States and published as WO2007/143840 on Dec. 21, 2007, applicants have found that the optimal dewatering apparatus contains several isolated electro-dewatering blocks/stages to allow for varying electro-dewatering conditions as the substance moves along the dewatering process. This application also discloses that the dewatering apparatus can include a system for applying an electrolyte to the sludge. The entire content of patent application PCT/CA2007/001052 as well as of its priority applications, namely U.S. patent application Ser. No. 60/804,703 filed Jun. 14, 2006 and 60/862,294 filed Oct. 20, 2006 is hereby incorporated by reference as if fully set forth herein.

In addition to intra-block “continuous” variations in pressure, current, voltage, etc, there is provided a means for “non-continuous” macro variations where each isolated block is independently operated and controlled by probes that measure parameters of importance to help determine the optimal amount of electrolyte to be added.

Input from probes that measure important parameters such as conductivity and voltage are sent to a controller which processes these data from each of the at least one electro-dewatering block or treatment stage. The measurements taken at the end of one stage or module will determine the amount of electrolyte addition to the substance before initiating treatment in the subsequent module or treatment stage. This method will ensure that the optimal amount of electrolyte is added to each stage of a multi-stage process or to each module of a modular apparatus. All inputs received by the controller are processed and allow for the determination of the optimal time, amount and location of electrolyte to be added. Other probes that measure humidity, thickness, temperature, current, voltage can also send input to the controller which will adjust the amount, timing and location of electrolyte addition based on as these measurements which are also known to play a role in electro-dewatering performance. Alternatively, in a one stage treatment process or mono-modular apparatus, electrolyte can be added initially based on probe inputs or substance characteristics, and, following probe measurements after partial treatment, electrolyte can be added again.

Kondo teaches of a method to add electrolyte to increase conductivity of a sludge in the Japanese Pub. No 60-114315. There are three fundamental differences between the Kondo patent and the present invention: 1. the requirement for depositing the electrolyte at the electrode substance interface rather than mixing electrolyte into the substance; 2. the concentration of electrolyte required to achieve an increase in the efficiency of electro-dewatering, and; 3. the types of electrolytes used. In the teachings of Kondo, electrolyte (which is only sodium chloride or seawater) is added in quantities much greater than those used in the present invention and the reason is that Kondo must impregnate or mix electrolyte into the sludge, thus the resistivity of the material is reduced and the electrical current is increased. Furthermore, Kondo uses an initial sludge which is highly liquid (99.4% water content), rendering it impossible to apply electrolyte only at the electrode-substance interface. Applicants use herein a pre-thickened sludge which allows electrolyte to be applied to and remain for a short period on the surface until electro-dewatering treatment is initiated.

In addition, applicants clearly demonstrate herein that higher electrolyte concentrations can lead to less efficient electro-dewatering processes due to the higher energy input required to dewater an electrolyte-rich substance. Indeed, an electrolyte-rich substance (that contains large amounts of electrolyte) will conduct more electricity but, overall, will be less efficient than a substance which contains the lowest amount of electrolyte at which a voltage loss at the anode is prevented. The present invention allows for the compensation of only the voltage lost near the anode by adding only the necessary amount of ions needed to improve electro-dewatering efficiency. Electrolyte is added immediately before treatment or during the intermission between successive treatment phases as long as the electrical current is initiated immediately after the addition of electrolyte and before significant impregnation of electrolyte into the substance can occur.

Electrolyte solutions can contain, but are not limited to, at least one or any combination of the following: CaCl₂, NaCl, Ca(NO₃)₂, NaPO₄, K₂CO₃, Na₂CO₃, NaHCO₃, HCl, H₂SO₄, C₆H₈O₇ (citric acid), Na₂SiO₃, CaCO3, CaO, KCl, Ca(CH2COO)2, K2PO4. Essentially the cation moiety can be any one or combination of calcium, sodium, potassium, magnesium, hydrogen (or any member of family IA or IIA of the periodic table of elements) and the anion moiety can be any one or combination of chloride, nitrate, carbonate, sulphate and/or oxygen (or any negatively charged atom or molecule).

It is yet another object of the present invention to provide an electrolyte with acidic properties in order to lower the pH inside the substance and/or the liquid extracted wherein the hydrogen ion participates in the electro-osmotic process and can also contribute, if in sufficient quantity, to the removal of deposits that typically form at and/or near the cathode and prevent the evacuation of water. For example, calcium carbonate residues are known to accumulate near the cathode and therefore adding an acid to lower the pH favours the solubilisation and thus liberation of calcium into the filtrate or extracted liquid. Furthermore, lowering pH of the substance can help to precipitate out metals from the liquid portion of the substance wherein the electric current causes the metals to migrate toward the cathode.

It is an object of the present invention to provide a method and apparatus which allows an electrolyte to be essentially deposited at the electrode-substance interface with the electro-dewatering process programmed to be initiated immediately after addition. A controller can respond to probe signals in order to maximize the efficiency of the electro-dewatering process.

It is an object of the present invention to provide an apparatus for the efficient addition of electrolytes to the surface of a substance to be electro-dewatered. Electrolyte addition can be performed directly by an electrode or by a structure adjacent to an electrode. The electrolyte can be vaporized onto the sludge of it can be deposited onto the sludge in liquid, solid, gaseous or plasma form, as long as electrolytes are dispersed onto the substance to be dewatered. The apparatus can further comprise any one or combination of a nozzle to spray the electrolyte onto the substance, an electrode adapted to deposit the electrolyte onto the substance, an electrode adapted to serve as a controlled electrolyte reservoir, wherein the reservoir contains an absorbent material that is saturated with electrolyte such that electrolyte losses are prevented during electrode lifting between successive treatment phases, an electrode adapted to electro-inject electrolyte onto the substance, an electrode adapted to spray the electrolyte onto the substance, a roller apparatus adapted to spread the substance and concomitantly, or not, add the electrolyte, a filter/cloth impregnated with electrolyte and placed between the electrode and the substance.

### BRIEF DESCRIPTION OF THE DRAWINGS

The invention will be better understood by way of the following detailed description of embodiments of the invention with reference to the appended drawings, in which:

FIG. 1 is a schematic representation of voltage as a function of distance between two electrodes for three time points, highlighting the consequence of subjecting an electrolyte-poor substance to electro-dewatering.

FIG. 2 is a schematic representation of one embodiment of an apparatus for depositing an electrolyte at an anode-substance interface and applying current and pressure between two electrodes. The inset is a 3-D representation of the electrolyte and substance layers with the various axes.

FIG. 3 is a graph showing the final dryness achieved in the three electro-dewatering conditions tested: without electrolyte (none), with electrolyte deposited at the electrode-substance interface (surface) and with electrolyte mixed into the substance (mixed).

FIG. 4 is a graph showing the Energy expenditure (kWh) per ton of liquid extracted (TLEx) as a function of electrolyte addition without electrolyte (none), with electrolyte deposited at the electrode-substance interface (surface) and with electrolyte mixed into the substance (mixed).

FIG. 5 is a graph of current density as a function of time in the three electro-dewatering conditions tested: without electrolyte (none), with electrolyte deposited at the electrode-substance interface (surface) and with electrolyte mixed into the substance (mixed).

FIG. 6 is a graph of the Final Dryness as a function of electrolyte concentration, when added to the surface of the substance to be dewatered.

FIG. 7 is a graph showing Final Dryness as a function of applied voltage for experimental conditions with electrolyte added to the surface of a substance and without electrolyte.

FIG. 8 illustrates of several possible embodiments of apparatuses designed to add electrolytes to an electrode-substance interface.

FIG. 9 is a graph showing dryness levels achieved as a function of time for electrolytes calcium chloride, calcium nitrate, sulphuric acid and a no electrolyte control.

FIG. 10 is a histogram showing the overall efficiency of electrolytes calcium chloride, calcium nitrate, sulphuric acid and a no electrolyte control.

FIG. 11 is a graph showing dryness level as a function of time comparing various surfactants and electrolytes.

FIG. 12 graphs the effect of electrolyte on the relationship between hedonic tone and dryness levels of a sludge.

FIG. 13 is a graph showing sludge dryness as a function of Inlet Sludge Flow Rate (FIG. 13A) and Return On Investment (FIG. 13B).

FIG. 14 is a graph showing Efficient Voltage (FIG. 14A) and Dryness (FIG. 14B) as a function of Time for experimental conditions with and without electrolyte

### DETAILED DESCRIPTION

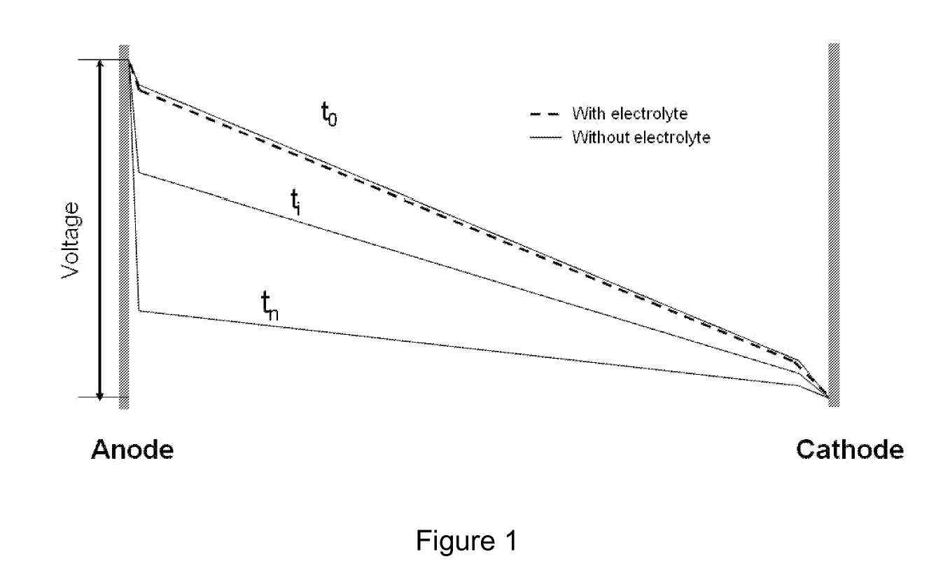

An electro-dewatering apparatus is known in the art and is more fully described in publication WO2007/143840. Referring now to the present application, FIG. 1 is a schematic representation of voltage as a function of distance between two electrodes for three time points without electrolyte (solid line) and with electrolyte (dashed line), highlighting the consequence of subjecting an electrolyte-poor substance to electro-dewatering. This image shows the drawbacks of the prior art whereby generating a current through a porous liquid-bearing substance rapidly leads to a decrease in voltage as a function of time and as a function of distance from the anode. The main reason that a zone of increased resistance appears near the anode is the outflow of cations away from the anode toward the cathode, thereby drawing water to the cathode and generating a crusty substance near the anode. This crusty substance has the property of severely limiting the amount of current that can flow through the substance. Several techniques have been developed to circumvent this drawback and it can be seen in FIG. 1 that the potential across the anode and cathode is significant at the onset of electro-dewatering but as the process continues, the potential decreases with time until at some point becomes insignificant, thereby creating inefficient dewatering conditions. When the potential nears zero, the electrical energy is converted to heat rather than inducing an electric field to force the movement of ions in the substance (i.e. efficient energy). Adding electrolyte decreases or prevents the drop in potential that occurs near the anode and therefore, the presence of electrolytes will cause curves Tᵢ and Tₙ to be substantially closer to Tₒ (see dashed line) for all times tested, as long as electrolyte is in still in sufficient quantity to have an effect at Tₙ.

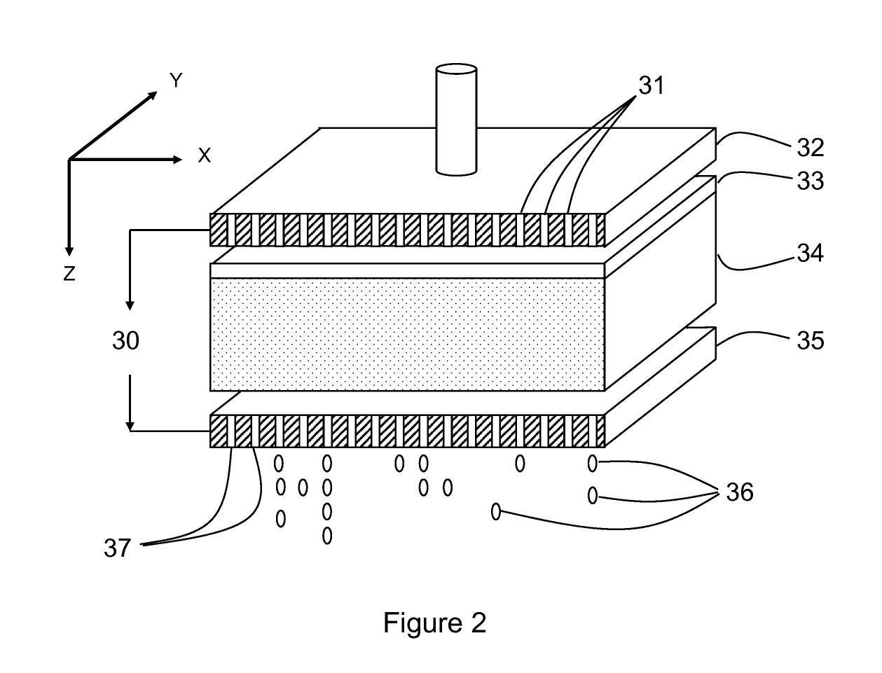

FIG. 2 is a schematic representation of one embodiment for depositing an electrolyte 33 at an anode-substance interface and applying current and pressure 30 between two electrodes 32 and 35. The white rectangles incorporated into the first electrode 32, in this case the anode comprise nozzles 31 which can evenly distribute an electrolyte 33 over a substance 34 to be treated, in this case wastewater sludge. The white rectangles on the bottom electrode 35, in this case the cathode, represent a configuration adapted to allow evacuation of fluids 36, in this case, perforations 37 that allow water 36 extraction. It is an important aspect of this invention that no mixing occurs between the step of adding the electrolyte onto the substance and the step of initiating the electro-dewatering process (i.e. current and pressure). The inset of FIG. 2 is a 3-D representation of the electrolyte and substance layers with the various axes, whereby the x- and y-axes correspond essentially to the horizontal surface of the spread substance 34 and the z-axis corresponds to the thickness of the spread substance.

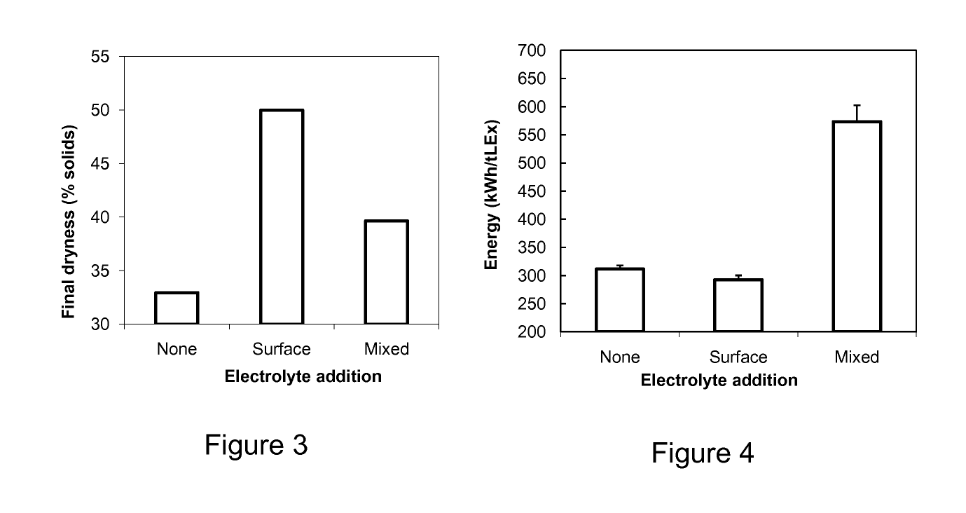

FIG. 3 is a graph showing the final dryness achieved during an identical 10 minute treatment in three experimental conditions consisting of without electrolyte addition (none), with electrolyte deposited only at the electrode-substance interface (surface) and with electrolyte homogenously mixed into the substance (mixed). All experiments were performed on a laboratory scale dewatering chamber described in more detail in US patent Pub. No. 20050016870. Briefly, the experimental substance, wastewater sludge from the sewage treatment plant of Victoriaville, Canada was split into three equal parts. For the first part (none), sludge was mixed thoroughly, placed into the chamber and submitted to the standard electro-dewatering protocol. For the second part, sludge was mixed thoroughly, placed into the chamber, a 10% electrolyte solution of 10 ml volume was deposited over the entire top surface of the sludge, and then, before significant impregnation or mixing could occur, submitted to the standard electro-dewatering protocol described above. Finally, in the third part, a 10% solution of electrolyte (10 ml volume) was added to the sludge, mixed thoroughly and added to the chamber, at which point the standard electro-dewatering protocol was initiated. FIG. 3 shows the final dryness levels attained in the three experimental conditions. It can be appreciated that, when all other conditions are the same, adding an electrolyte to the surface of the sludge without mixing or impregnation offers the highest final dryness level of the three experimental conditions tested, reaching levels of 50% dryness, as compared to 39% for the mixed electrolyte and 33% for the no electrolyte condition. Dryness is evaluated using a standard test whereby the substance is submitted to high temperatures (105° C.) until two successive weightings show no significant variation, i.e. all water has been evaporated. Error bars represent the standard deviation of two independent experiments.

FIG. 4 is a graph showing the Energy expenditure (kWh) per ton of liquid extracted (tLEx) up to 30% dryness in three experimental conditions consisting of without electrolyte addition (none), with electrolyte deposited only at the electrode-substance interface (surface) and with electrolyte homogenously mixed into the substance (mixed). Because the same three experimental conditions used in FIG. 3 led to very different final dryness levels and because energy required to remove the first drop of water is lower than that of the second drop, applicants calculated the energy required to reach the dryness level of the lowest common denominator. All experiments were performed in a laboratory scale dewatering chamber described in more detail in US patent Pub. No. 20050016870. Briefly, the experimental substance, a wastewater sludge from the sewage treatment plant of Victoriaville, Canada, was split into three equal parts and, after electrolyte addition or not, submitted to electro-dewatering. For the first part (none), sludge was mixed thoroughly, placed into the chamber and submitted to a standard electro-dewatering protocol similar to that described in FIG. 3. For the second part, sludge was mixed thoroughly, placed into the chamber, 1 g of electrolyte was deposited over the entire top/horizontal surface of the sludge, and, before significant impregnation or mixing could occur, submitted to the standard electro-dewatering protocol described above. Finally, in the third part, the same amount of electrolyte as in part 2 was added to the sludge, mixed thoroughly for 5 minutes until electrolyte was homogenously mixed into the sludge and added to the chamber, at which point the standard electro-dewatering protocol was initiated. FIG. 4 shows the Energy expenditure per ton of water extracted attained in the three experimental conditions described. Because it is well known in the art that the mere presence of an electrolyte will increase conductivity of a substance and thus current passing therethrough, applicants were surprised to note that adding electrolyte to the surface of the substance (292 kWh/TLEx) led to a slightly lower energy consumption than the no electrolyte control (311 kWh/TLEx). Even more surprisingly however, the homogenously mixed electrolyte condition revealed a significantly higher energy consumption (573 kWh/TLEx) than the other two experimental conditions. These results make a very strong case for the advantageous nature of the invention disclosed herein. Error bars represent the standard deviation of two independent experiments.

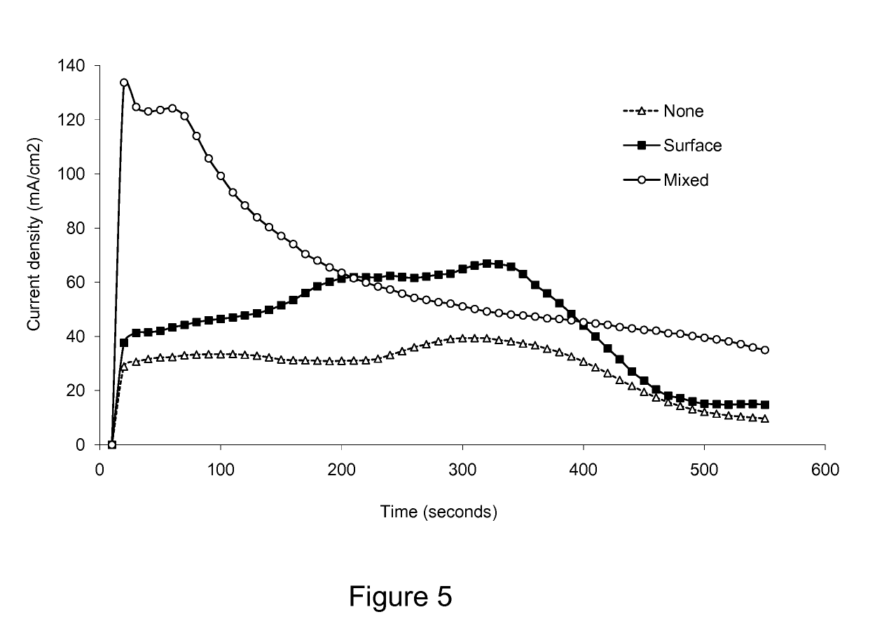

FIG. 5 is a graphic of current density as a function of time in the three electro-dewatering conditions described above: without electrolyte (none), with electrolyte deposited at the electrode-substance interface (surface) and with electrolyte mixed into the substance (mixed). It can be appreciated from this figure that, although the current density for all three experimental conditions increases very rapidly at the onset of electro-dewatering, the surface deposited electrolyte and no electrolyte conditions taper off rapidly and allow lower current density than that of the homogenously mixed electrolyte. This figure nicely illustrates why the energy expenditure in FIG. 4 is higher for the mixed electrolyte condition than the two other conditions tested. Indeed, because in the mixed condition the electrolyte is homogenously dispersed throughout the substance, the current density can be maximised at the onset of electro-dewatering. However, because the absolute electrolyte quantity found at the vicinity of the anode is lower, the beneficial effect of electrolyte decreases rapidly. When the total amount of electrolyte is placed directly at the anode substance interface (surface deposited), even though electrolyte concentration at the cathode is initially lower, a sufficient amount of electrolyte at the anode will compensate the drop in potential which decreases the efficiency of electro-dewatering.

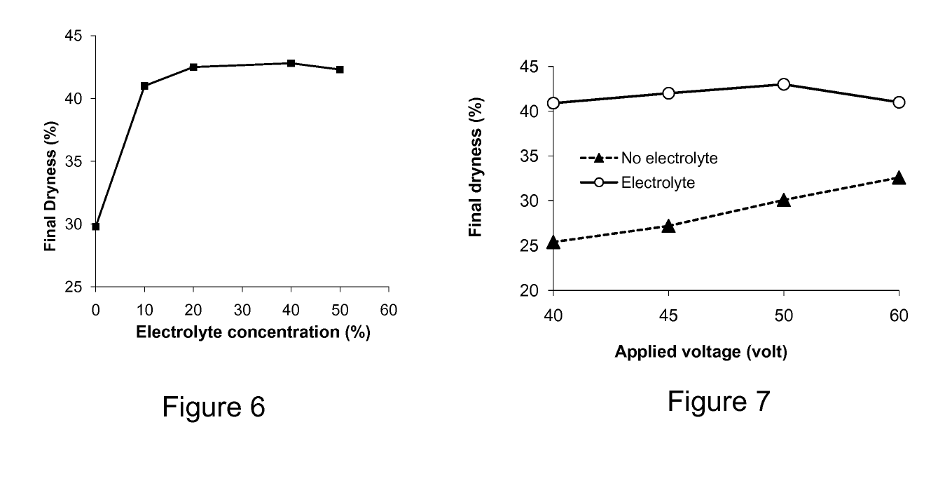

FIG. 6 is a graph of the Final Dryness as a function of electrolyte concentration, when added to the surface of the substance to be dewatered. The experimental conditions were similar to those used in the previous FIGS. 3-5 except that the optimal electrolyte addition method was used to evaluate the concentration ranges of electrolyte that allow for the most efficient electro-dewatering in terms of final dryness levels achieved. It can be appreciated from the graph that low concentrations (10%) of electrolyte deposited at the electrode-substance interface generate similar final dryness levels (41% TSS) than those of 20, 40 and 50% concentrations which showed final dryness values of 43, 43, 42% TSS, respectively. These results suggest that the most efficient concentration among those tested is 10%. Indeed, anything above 10% generates similar dryness levels and similar energy expenditures, strongly suggesting that the extra electrolyte does not participate in a significant way to the electro-dewatering process. Indeed, if surface-deposited concentrations above 10% are used, the extra electrolyte might remain at the electrode-substance interface and not participate in the electro-dewatering process and therefore not allow for greater current to pass through the substance. These results strongly suggest that a lower quantity of electrolyte is more efficient than a higher quantity because in the case of a higher quantity, extra electrolyte is just wasted. Furthermore, electrolyte remaining at or near the electrode surface interface at the end of electro-dewatering will contribute to the final weight of the sludge. Because most electro-dewatering processes and plants pay a weight-based disposal fee for their sludge, it would be highly inefficient to pay extra to add electrolyte material that will not serve in the electro-dewatering process and then again pay extra for get rid of it as it contributes to the final weight of the electro-dewatered substance. Finally, all concentrations of electrolyte tested gave final dryness values that were significantly higher than those without any electrolyte added.

FIG. 7 is a graph showing Final Dryness as a function of applied voltage for experimental conditions with electrolyte added to the surface of a substance and without electrolyte added. Voltages ranging from 40 to 60 volts were tested with electrolyte and without any electrolyte added. It can be appreciated from this figure that at all voltages tested, the presence of electrolyte had a beneficial effect, generating final dryness values of 41%, 42%, 43% and 41%, as compared to final dryness values without electrolyte of 25%, 27%, 30% and 33% for 40V, 45V, 50V and 60V in both experiments, respectively. The beneficial effect of electrolyte addition appears to be more pronounced at the lower range of voltages tested as the difference in final dryness gets smaller with increasing voltages. This observation can be explained by the fact that at very high voltages, some of which would not be industrially applicable, the potential drop observed at the anode is overcome and despite the presence of a crusty material at the anode, sufficient current can pass though the substance to dewater it. In an industrial setting however and in settings where energy expenditure is a significant expense, the energy cost and the heat generated at such high voltages would make, overall, for an inefficient process.

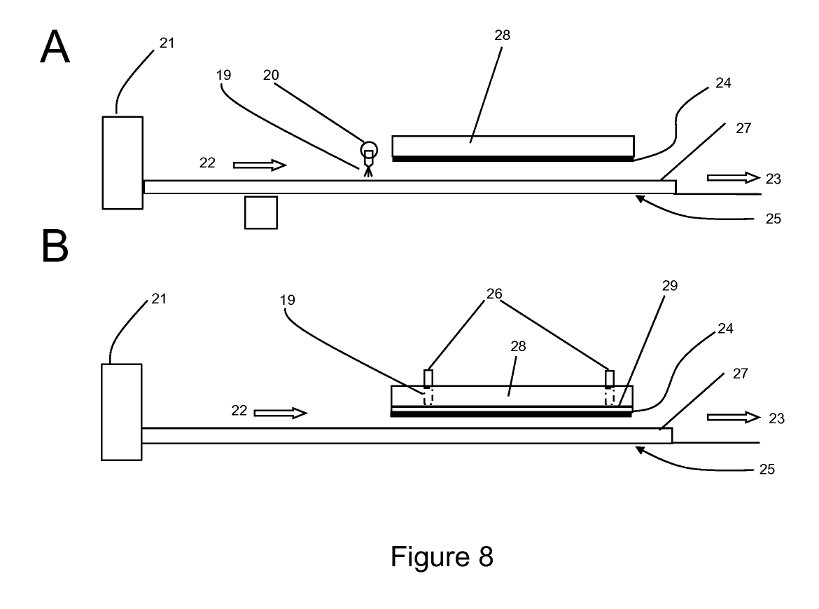

FIG. 8 is an illustration of several examples of electro-dewatering apparatuses and mechanisms adapted to add an electrolyte to an electrode-substance interface. FIG. 8A shows one embodiment whereby the electrolyte 19 is added by a nozzle 20 which is situated in between the feeding apparatus 21 and the electro-dewatering zone or through filing chambers 26. Sludge inlet 22 and outlet 23 are illustrated with the anode 24 on top and the cathode 25 on the bottom. The substance 27 to be dewatered is shown adjacent to the cathode 25 for gravity reasons however, during treatment; the anode is lowered to establish a constant contact and pressure against substance. An isolating plate 28 is also shown and is important for electrical isolation between anode 24 and rectifiers (not shown). FIG. 8B also shows an embodiment wherein the isolating plate 28 adjacent to the anode 24 is adapted to hold electrolyte 19 and dispense it when needed, thus acting as an electrolyte reservoir 29 which can also comprise a filter cloth. The addition of electrolyte 19 to the reservoir 29 is through filling chambers 26 and the electrolyte is added to the substance through sprayers, nozzles, drippers, electro-injectors or any method that allows a substantially homogenous dispersion of the electrolyte over the entire surface of the substance to be electro-dewatered.

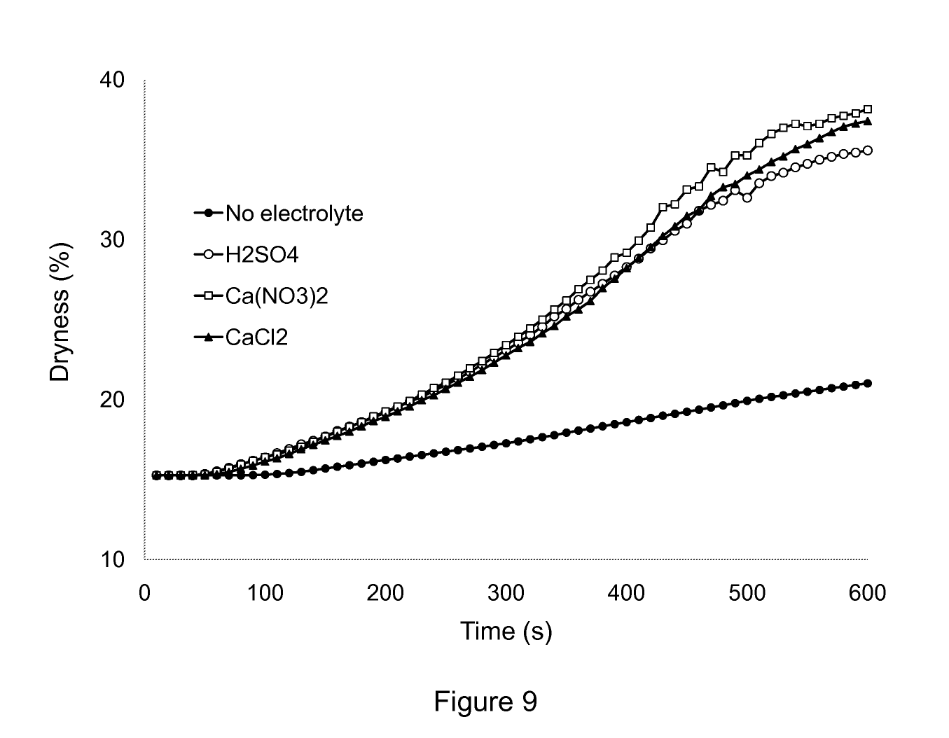

FIG. 9 is a graph showing dryness levels achieved using various electrolytes. All three electrolytes tested performed very significantly better than the no electrolyte control as sulphuric acid, calcium nitrate and calcium chloride addition resulted in final dryness levels after 600 seconds of 35.6%, 38.2% and 37.4%, respectively, as compared to the no electrolyte control which yielded 21.0%. The dryness percentages graphed in FIG. 9 are extrapolated from the amount of water extracted, as weighed in the laboratory setup. However, when the substance is submitted to a standard dryness test as described in FIG. 4, the final dryness levels reached at the end of treatment were 47.3% for sulphuric acid, 45.2% for calcium nitrate and 46.4% for calcium phosphate, as compared to the no electrolyte control which yielded a final dryness of only 22.9%. In the experiments shown in FIG. 9, the quantity of electrolyte added is approximately 0.009 milliliters (6N H₂SO₄)/cm² of anode surface.

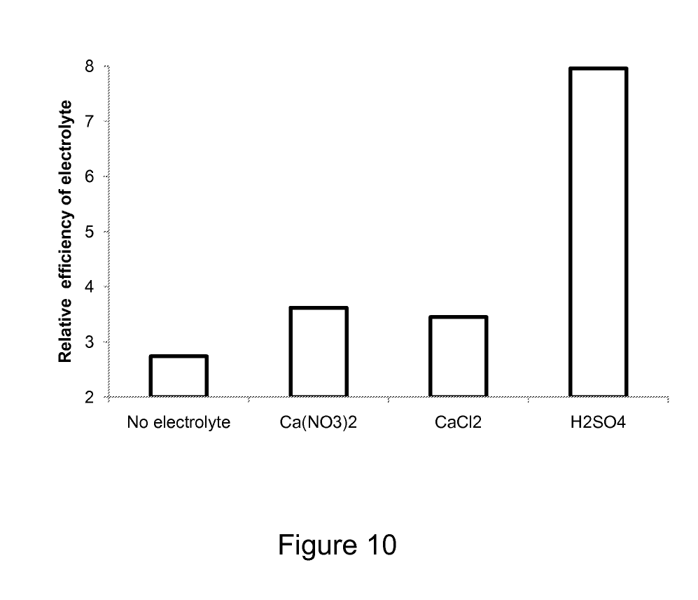

FIG. 10 is a histogram showing the overall efficiency of electrolytes calcium chloride, calcium nitrate, sulphuric acid and a no electrolyte control. Results show the overall efficiency of electro-dewatering without electrolyte compared to that in the presence the three electrolytes tested wherein the electrolyte is applied at the surface of the sludge and the electro-dewatering process is initiated before impregnation of the electrolyte into the substance can occur. It can be appreciated from FIG. 10 that sulphuric acid is much more efficient than both calcium salts tested. Overall efficiency is determined based on the cost of electrolyte, the cost of energy involved in the process, the amount and rate at which sludge goes into the process and the amount of sludge leftover after electro-dewatering process. Efficiency is thus calculated as the inverse of cost per hour divided by ton sludge, multiplied by ton sludgeₒᵤₜ. Experiments were performed essentially according to the same experimental protocols as those presented in FIGS. 3-7 and 9.

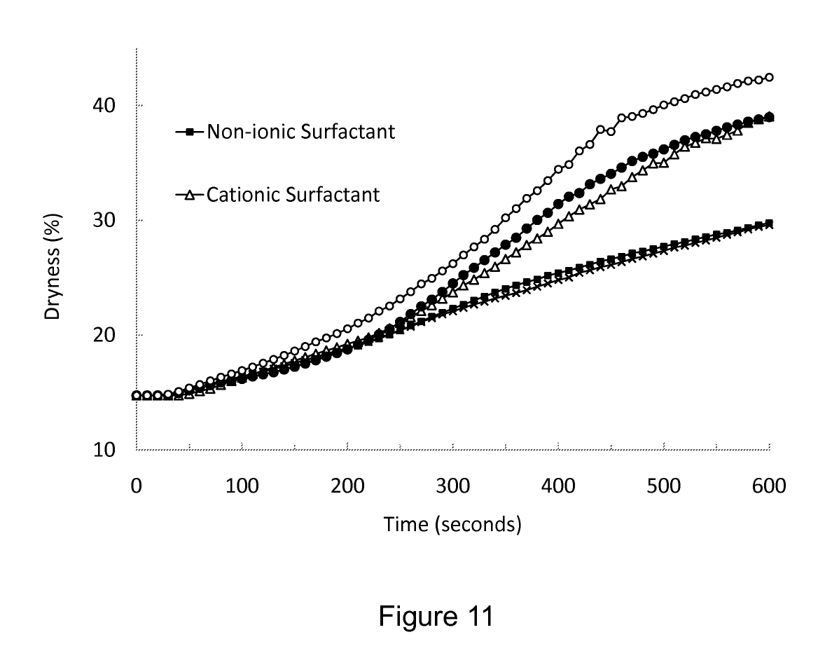

FIG. 11 shows dryness results, measured by the total liquid lost, as a function of electro-dewatering time, obtained using various surfactants. It can be appreciated that, of the Magnor surfactants tested, only ionic surfactants were shown to improve dewatering efficiency. Indeed, surfactants Magnor 571080 (anionic) and Magnor 574563 (cationic) both significantly enhanced EDW in the experimental conditions used. On the other hand, non-ionic surfactant Magnor 573462 showed little to no increase in dryness compared to the no surfactant condition, suggesting that non-ionic surfactants cannot bind to water molecules and therefore not allow water to benefit from its transport capabilities. These results support the importance of ions in the mechanism by which electrolytes increase the efficiency of electro-dewatering.

Both anionic and cationic surfactants increased EDW efficiency, and all experimental results shown in FIG. 11 were performed on a low-conductivity municipal wastewater sludge. Results showed ionic surfactants were less efficient than sulphuric acid, however, no optimization studies were performed on the surfactants. It will be appreciated that the level of efficiency of electrolytes such as surfactants can depend on the original conductivity of the sludge such that adding electrolytes favours the current intensity and prevents a voltage loss observed at one electrode.

Some of the cationic surfactants tested were of quaternary type and demonstrated positive disinfection properties. Although surfactants in general can have germicidal properties, cationic surfactants show even greater germicidal potential.

It is useful to use amphoteric surfactant compounds because they can dissolve either in acidic or caustic solutions. This is very interesting for electro-dewatering as the “anode” surface of the sludge becomes acidic and the “cathode” surface becomes caustic. Amphoteric surfactants could potentially buffer liquids generated at both electrode surfaces and help prevent accumulation of debris at the cathode.

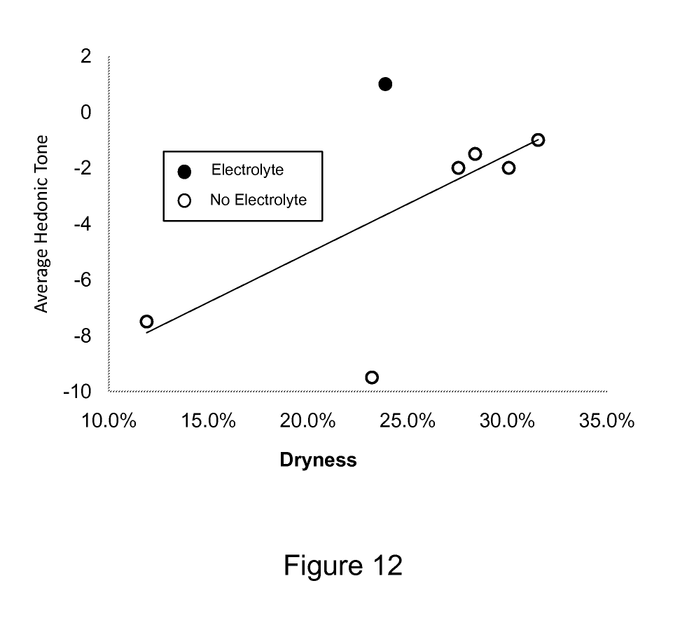

FIG. 12 and Table 1 show hedonic tone as a function of electrolyte type. Hedonic tone is a measure of the relative pleasantness/unpleasantness of odours and provides an indication of the likely offensiveness of odours. It can be used to grade odours before and after abatement, such as that achieved by electro-dewatering. Hedonic tone was measured using blinded subjects submitted to the smell of various sludge samples before and after electro-dewatering in the presence, or not, of an electrolyte. Table 1 shows, in more qualitative detail, 7 experimental conditions comprising 1 control sludge (non-electro-dewatered) and 6 sludge samples electro-dewatered to varying dryness levels. Subjects were asked to qualify the smell of each sludge based on a predetermined scale.

TABLE 1
Hedonic tone as a function of sludge dryness and electrolyte addition

| | Electro- | | Hedonic | | Hedonic | |
|---|---|---|---|---|---|---|
| Sample | lyte | Dryness | Tone | Character | Tone | Character |
| Control | N | 11.9% | −9 | raw manure | −6 | metallic/organic |
| 1 | N | 30.1% | −3 | rotten grain door | −1 | malt/earth |
| 2 | N | 23.2% | −11 | raw manure | −8 | metallic/fecal/ |
| | | | | | | decay/ammonia |
| 3 | Y | 23.9% | 3 | sweet corn-like | −1 | malt/earth |
| 4 | N | 28.4% | −1 | aerobic | −2 | metallic/organic |
| 5 | N | 27.5% | 1 | aerobic | −5 | metallic/organic/ |
| | | | | | | earth |
| 6 | N | 31.5% | 1 | aerobic | −3 | metallic/earth |

It could be useful to add scented electrolytes to further increase hedonic tone. For example, apple-scented sludge would likely rate higher on a hedonic tone index than non-scented sludge. Added scents can further increase the value of sludge for reuse in agriculture.

It will be appreciated by those skilled in the art that certain electrolytes are well suited to increase the efficiency of odour abatement during electro-dewatering processes. Indeed, using sodium chloride as an electrolyte, for example, can cause the formation of oxidising chlorine containing compounds in the sludge. Moreover, oxidising compounds generated naturally by the electrolysis of water at the electrodes (without externally added electrolyte) can kill one population of bacteria and odour causing pathogens. On the one hand, adding one electrolyte could kill more of the same population in a dose dependent manner but on the other hand, another electrolyte can kill a whole new population of bacteria in the “non-linear” concentration range, i.e. a concentration at which increasing or decreasing the electrolyte does not affect pathogen destruction. Thus, certain oxidising compounds can act in additive fashion while others will act synergistically.

In essence it is possible that some electrolytes will help eliminate more pathogens, and thus contribute to increase the normal odour abatement effect of electro-dewatering. It will be appreciated that many phenomena in the art of electro-dewatering can contribute to “sanitization” of sludge. Among these phenomena are generation of oxidising compounds at the electrodes, high temperature, high pressure and electrolytes. Table 1 and FIG. 12 show only one electrolyte which showed a beneficial effect on hedonic tone. Other electrolytes were tested that did not show similar results. A beneficial effect on hedonic tone should be understood as meaning a positive deviation from the trendline established between hedonic tone and dryness. It will be understood that electro-dewatering without electrolyte also has an effect on hedonic tone such that a clear relationship can be established between dryness and smell.

As mentioned above, water from electro-dewatered sludge brings along with it odour containing molecules/gases. For example, nitrogen, in the form of ammonia compounds, is liberated from bacteria during their electrolytic destruction process. These nitrogen compounds can be soluble in water and are evacuated through the dewatering process. Many other volatile and odorific gases are evacuated with the water component and these liquids are typically sent back to the wastewater treatment plant inlet.

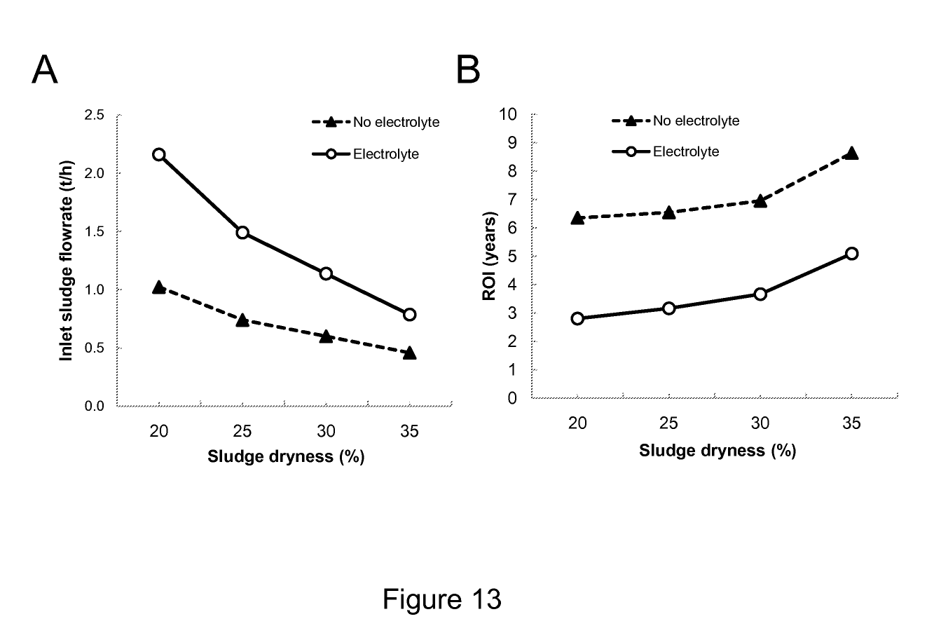

FIG. 13 is a graph showing sludge dryness as a function of Inlet Sludge Flow Rate (FIG. 13A) and Return On Investment-ROI (FIG. 13B). The experimental protocol was designed to measure many electro-dewatering parameters during electro-dewatering processes whereby sludge of initial dryness values of between 10-15% is electro-dewatered to final dryness values of 20%, 25%, 30% and 35%. It will be appreciated by those skilled in the art that many wastewater treatment plants can provide a sludge of up to 15% dryness using standard mechanical dewatering apparatuses such as a filter press, a screw press and a belt press. Furthermore some sludge types cannot reach higher dryness values than 35% without adding electrolyte. FIG. 13A shows that adding a small amount of electrolyte allows an EDW apparatus to take a 15% dryness sludge to 20% at a rate of 2.2 tons per hour as opposed to 1.0 ton per hour without electrolyte. This very significant 112% increase in efficiency decreases slightly as sludge dryness increases further such that a 72% increase in efficiency is observed when reaching 35% sludge dryness.

The ROI calculation used for plotting the graph of FIG. 13B considers the sale price of applicant's electro-dewatering equipment, installation and infrastructure cost, operation costs including electrolytes and energy (electricity), sludge transport/disposal costs, maintenance staff and operators. The y-axis represents the time in years for such an investment to be recovered i.e. return on investment (ROI). Once again, electrolytes display the highest efficiency when electro-dewatering sludge to a final dryness of 20% as the payback for such an apparatus would be 2.8 years with electrolyte compared to 6.3 years without electrolyte. Interestingly, the ROI for both electrolyte-treated and non-electrolyte-treated sludge increases with increasing sludge dryness requirements such that, although both curves appear parallel, the percentage increase decreases with dryness. Because these calculations include the cost of electrolyte, the significant benefit of electrolyte addition will nevertheless be appreciated by those skilled in the art as well as others.

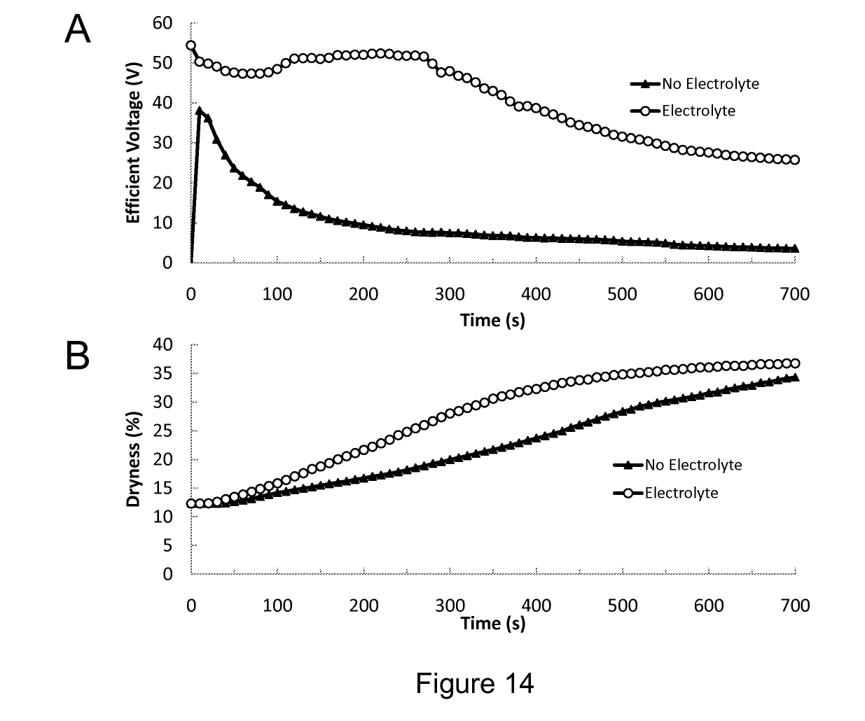

FIG. 14 shows Efficient Voltage and Dryness as a function of Time. In FIG. 14A, the data show that adding electrolyte has a profound effect on the voltage and current (not shown) throughout the duration of the electro-dewatering process (in this case 700 seconds), demonstrating how electrolytes provide protection against the observed voltage drop typically observed the anode. The voltage drop is mainly due to the formation of a crusty material that prevents electrical transfer through a substance. The voltage drop observed in the No Electrolyte series is significantly delayed in time and magnitude. It can be observed in FIG. 14B (which is the same experiment as that of FIG. 14A) that an increase in dryness attributable to the action of electrolytes is observable at a very early stage of the electro-dewatering process, in this case, approximately 25 seconds into the treatment. This is likely explained by the voltage drop observed in the No Electrolyte series.

The electrolyte used in FIGS. 13 and 14 is calcium nitrate and it was added at 0.0004% w/w (i.e. 0.03 g electrolyte/73.5 g sludge) which also corresponds to 0.00027 g/cm² anode surface (0.03 g of calcium nitrate and 111 cm² of anode surface area).

The electrolyte used in FIGS. 9 and 10 is sulphuric acid and it was added at 0.0004% w/w (i.e. 0.03 g electrolyte/73.5 g sludge) which also corresponds to 0.00027 g/cm² anode surface (0.03 g of calcium nitrate and 111 cm² of anode surface area).

The quantity of electrolyte added is an important consideration because, in order to maximise efficiency of the EDW process, one must use as little electrolyte as possible either for a predetermined treatment time or to reach a predetermined dryness value. In addition, electrolyte must be evenly spread/dispersed over the substance to be treated. If too much electrolyte is added, a higher cost of electrolyte and a higher cost of energy will be incurred and if the electrolyte is not evenly distributed, current channels will form in some areas of the sludge, thereby penalizing other areas of the sludge and wasting energy.

Salt-based electrolytes are understood to mean any electrolyte that has the chemical form characteristic of a salt. Acid-based electrolytes are understood to mean any electrolyte that has the chemical form characteristic of an acid. Surfactant-based electrolytes are understood to mean any ionic (cationic or anionic) surfactant.

1. A method for increasing dryness of a substance comprising:
a) placing said substance between at least two electrodes, at least one of which is adapted to allow fluid evacuation;
b) adding an electrolyte to one surface of said substance, wherein said surface is or will be at the interface between the substance and one of the electrodes, wherein a) and b) can be performed in any order;
c) before impregnation of said electrolyte into said substance can occur, submitting said substance to a combination of pressure and electrical current so as to remove liquid from said substance.

2-7. (canceled)

8. The method as claimed in claim 1 wherein the at least one electrode adapted to allow fluid evacuation is a cathode and the at least one electrode in contact with the electrolyte is an anode.

9. (canceled)

10. The method as claimed in claim 1 wherein a cationic part of the electrolyte added includes at least one or any combination of calcium, magnesium, sodium, potassium and/or hydrogen.

11. The method as claimed in claim 1 wherein an anionic part of the electrolyte added includes at least one or any combination of chloride, nitrate, carbonate, sulphate and/or oxygen.

12. The method as claimed in claim 1 wherein the substance to be treated is an organic sludge.

13-19. (canceled)

20. The method as claimed in claim 1 further comprising adding electrolyte as a function of conductivity and/or voltage.

21. The method as claimed in claim 20 wherein said conductivity and/or voltage is determined at one of prior to treatment, between stages in a multi-stage treatment and during treatment.

22-24. (canceled)

25. The method of claim 1 wherein said electrolyte is an ionic surfactant.

26. The method of claim 25 wherein said ionic surfactant is a Magnor anionic surfactant 571080.

27-30. (canceled)

31. The method of claim 1 further comprising adding scents to said electrolyte in order to increase at least one of the value and hedonic tone of said substance.

32-34. (canceled)

35. A method for preventing a voltage drop at a substance-electrode interface during electro-osmotic treatment comprising adding an electrolyte at a substance-electrode interface and initiating said treatment before significant impregnation of said electrolyte into said substance can occur.

36. An apparatus for increasing dryness of a substance, said apparatus comprising at least two electrodes adapted to submit said substance to an electric current and pressure, said apparatus adapted to deliver an electrolyte at an electrode-substance interface, thereby reducing or preventing a voltage loss that occurs during treatment by electro-osmosis; wherein a controller is programmed to initiate treatment before impregnation or permeation of said electrolyte into said substance can occur.

37. The apparatus as claimed in claim 36 wherein said controller controls the addition of electrolyte either during treatment or at intervals of a multi-stage treatment.

38. The apparatus as claimed in claim 36 further comprising conductivity and/or voltage probes to measure conductivity and/or voltage of said substance.

39. The apparatus as claimed in claim 36 wherein an inlet for receiving said substance is adapted to spread said substance and add said electrolyte to said substance.

40-41. (canceled)

42. The apparatus as claimed in claim 36 further comprising an electrode adapted to serve as a controlled-release electrolyte reservoir.

43-44. (canceled)

45. The apparatus as claimed in claim 36 further comprising a roller apparatus adapted to spread the substance and concomitantly add electrolyte.

46. The apparatus as claimed in claim 36 further comprising a filter/cloth adapted to be impregnated with electrolyte and placed between said electrode and said substance.

47. The apparatus as claimed in claim 36 wherein a cationic part of the electrolyte includes at least one or any combination of calcium, magnesium, sodium, potassium and hydrogen.

48. The apparatus as claimed in claim 36 wherein an anionic part of the electrolyte includes at least one or any combination of chloride, nitrate, carbonate, sulphate and oxygen.

49-52. (canceled)
